(19) United States
(12) Patent Application Publication
(10) Pub. No.: US 2025/0091165 A1
(43) Pub. Date: Mar. 20, 2025

(54) Reduced Manganese Low Carbon Steel Arc Welding Electrodes

(71) Applicant: ESAB Europe GmbH, Steinhausen (CH)

(72) Inventors: Suresh TELU, Chennai (IN); Meenakshi ANNAMALAI, Virugambakkam (IN); M. R. ARUNKUMAR, Chennai (IN)

(21) Appl. No.: 18/414,617

(22) Filed: Jan. 17, 2024

(30) Foreign Application Priority Data
Sep. 14, 2023 (IN) 202341061897

(51) Int. Cl. B23K 35/362

(52) U.S. Cl. CPC B23K 35/362

(57) ABSTRACT

A welding consumable includes a metallic core, and a flux coating surrounding a portion of the metallic core. The flux coating includes a reduced manganese content, which results in a significant reduction of manganese in the weld fumes formed when the welding consumable is consumed in an arc welding process.

### CROSS-REFERENCE

This application claims priority to and the benefit of India patent application No. 202341061897, entitled “REDUCED MANGANESE LOW CARBON STEEL ARC WELDING ELECTRODES,” filed Sep. 14, 2023, which is hereby incorporated in its entirety for all purposes.

### FIELD

Embodiments of the invention generally relate to welding consumables or welding electrodes, and, more particularly to flux covered consumables or stick electrodes, such as electrodes for shielded metal arc welding (SMAW) or manual metal arc welding (MMAW).

### BACKGROUND

In shielded metal arc welding (SMAW), the flux coating covering the stick electrode forms vapors that provide a shielding gas to the molten pool and provide a slag over the formed weld metal during the welding process. Certain components in the flux can be harmful to the welder if high concentrations are introduced into the shielding gas.

For example, manganese is typically present in the flux coating of SMAW electrodes, since it functions as a deoxidizer and a desulfurizer. Due to its high vapor pressure, its transferring efficiency to the weld metal is low. In order to get the desired amount of Mn into the weld metal (e.g., in order to provide certain desirable properties for the weld, e.g., strength, toughness and/or hardness properties), the amount of Mn in the flux coating tends to be high. This in turn can present serious exposure to a welder of fumes including Mn during the welding process. It would be desirable to reduce Mn content in the SMAW welding process while ensuring the formation of a weld metal having desirable properties.

### SUMMARY

In example embodiments, a welding consumable is provided as described herein. For example, a welding consumable may comprise a metallic core, and a flux coating surrounding a portion of the metallic core, where the flux coating comprises, by weight of the flux coating:
manganese in an amount no greater than 4 wt %;
carbon in an amount from 0.01 wt % to 0.5 wt %;
silicon in an amount from 2 wt % to 3.5 wt %; and
at least two of the following:
   nickel in an amount no greater than 2 wt %;
   chromium in an amount no greater than 2 wt %;
   titanium in an amount no greater than 10 wt %; and
   boron in an amount no greater than 5 wt %.

In addition, a weld metal deposit may be formed utilizing the welding consumable as described herein. For example, the weld metal deposit may comprise, based upon a weight of the weld metal deposit:
from wt. % 0.03 to 0.08 wt. % carbon,
from 0.4 wt. % to 0.6 wt. % manganese,
from 0.3 wt. % to 0.7 wt. % silicon,
one or more of:
   no greater than 0.3 wt. % nickel,
   no greater than 0.2 wt. % chromium,
   no greater than 0.2 wt. % molybdenum,
   no greater than 0.1 wt. % cobalt,
   no greater than 0.1 wt. % titanium,
   no greater than 0.1 wt. % boron,
optionally one or more of:
   no greater than 0.2 wt. % vanadium,
   no greater than 0.2 wt. % niobium,
   no greater than 0.2 wt. % copper,
   no greater than 0.2 wt. % aluminium,
   no greater than 0.2 wt. % rare earth elements, and
the balance iron and any unavoidable impurities.

The above and still further features and advantages of the present invention will become apparent upon consideration of the following detailed description of specific embodiments thereof.

### BRIEF DESCRIPTION OF THE DRAWINGS

The accompanying drawings illustrate example embodiments of the disclosed method so far devised for the practical application of the principles thereof, and in which:

FIG. 1 is a plot of fume emission rate (in mg/s) and Manganese content in welding fume (in mg/s) at varying heat inputs. (in kJ/mm).

FIG. 2 is a plot of fume emission rate (in mg/s) at varying amounts of Mn in the flux coating (in wt % of flux coating) at a constant heat input of 1.2 kJ/mm and while maintaining all other elements and components in welding electrode the same.

FIG. 3 is a plot of Mn content in welding fume (in wt % of the fume) at varying amounts of Mn in the flux coating (in wt % of flux coating) at a constant heat input of 1.2 kJ/mm and while maintaining all other elements and components in welding electrode the same.

FIG. 4 is a plot of Yield Strength and Tensile Strength (both in MPa) of a weld metal deposit formed when performing SMAW welding with a flux coated electrode at varying amounts of Mn in the flux coating (in wt % of flux coating) at a constant heat input of 1.2 kJ/mm and while maintaining all other elements and components in welding electrode the same.

FIG. 5 is a plot of Impact Toughness (at −40° C., in Joules) of a weld metal deposit formed when performing SMAW welding with a flux coated electrode at varying amounts of Mn in the flux coating (in wt % of flux coating) at a constant heat input of 1.2 kJ/mm and while maintaining all other elements and components in welding electrode the same.

FIG. 6 is a plot of fume emission rate (in mg/s) of a conventional flux coated electrode vs. example embodiments of other flux coated electrodes with reduced Mn in the flux coating as described herein.

FIG. 7 is a plot of Mn content in the welding fume (in wt % of fume) of the conventional flux coated electrode vs. example embodiments of other flux coated electrodes with reduced Mn in the flux coating as described herein.

### DETAILED DESCRIPTION

Various welding consumable embodiments are described in this specification to provide an overall understanding of the invention. It is understood that the various embodiments described in this specification are non-limiting and non-exhaustive. Thus, the invention is not limited by the description of the various non-limiting and non-exhaustive embodiments disclosed in this specification. In appropriate circumstances, the features and characteristics described in connection with various embodiments may be combined with the features and characteristics of other embodiments. Such modifications and variations are intended to be included within the scope of this specification. As such, the claims may be amended to recite any steps, elements, limitations, features, and/or characteristics expressly or inherently described in, or otherwise expressly or inherently supported by, this specification. Further, Applicants reserve the right to amend the claims to affirmatively disclaim steps, elements, limitations, features, and/or characteristics that are present in the prior art regardless of whether such features are explicitly described herein. The various embodiments disclosed and described in this specification can comprise, consist of, and/or consist essentially of the elements, limitations, features, and/or characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicants reserve the right to amend this specification to expressly recite any subject matter, or portion thereof, incorporated by reference herein.

The grammatical articles “one”, “a”, “an”, and “the”, if and as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

Described herein are flux coated welding consumables or electrodes (e.g., SMAW electrodes) comprising a metallic core and a flux coating that surrounds or covers a portion (e.g., a substantial portion including the outer periphery of) the metallic core. The electrodes include a manganese (Mn) content that is significantly lower than conventional electrodes of the same type. As used herein, the terms “electrode” and “consumable” are used interchangeably and have the same meaning with regard to welding. In particular, the Mn content in the flux coating of the electrodes can be limited to no greater than 5.5% by weight (wt %) of the flux coating, preferably no greater than 4 wt % of the flux coating, even more preferably no greater than 3 wt % or no greater than 2 wt % of the flux coating. In example embodiments, the flux coating is limited to no greater than 1.5 wt % of the flux coating for flux coated electrodes.

The reduction of Mn content in a flux coated electrode from conventional amounts can, without any further modification to the electrode, result in the formation of weld metals having undesirable physical properties, such as lower yield strength, lower tensile strength, etc. However, it has been determined that the addition of certain other metals and/or other components to the welding electrode as described herein can compensate and enhance physical properties of the weld metal that meet and/or exceed welding standards for a particular application.

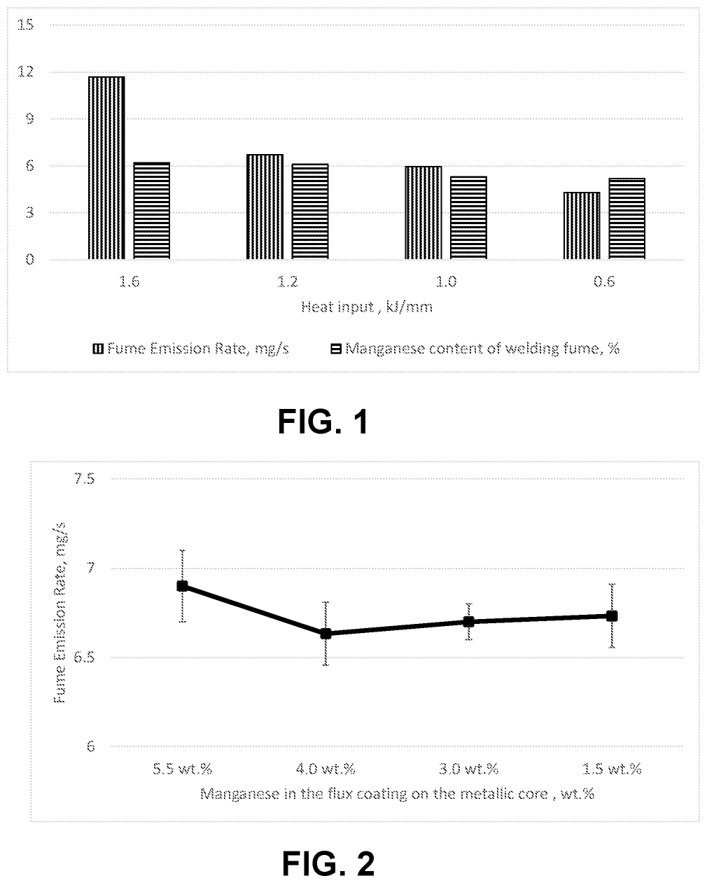

The data plotted in FIGS. 1-6 shows the effects of reducing Mn in otherwise conventional SMAW wires. In particular, conventional E7018 stick electrodes (4 mm in diameter) were studied using a flux coating that was varied in Mn content from 1.5-5.5 wt % of the flux coating. The flux coating of the conventional E7018 electrode typically includes the following based on the weight of the flux coating: Mn in an amount of about 4 wt %, Si in an amount of about 1.8 wt %, and C in an amount of about 0.05 wt %,

Referring to FIG. 1, a flux coating provided on the core includes Mn in an amount of 4 wt % of the flux coating. The fume emission rate and Mn content of the welding fume were determined based upon a change in heat input for flux coated E7018 electrodes with such Mn content in the flux coating. Welding fume tests were conductedusing procedures defined in AWS F1:2:2006, “Laboratory Method for Measuring Fume Generation Rates and Total Fume Emission of Welding and Allied Processes”, the entire disclosure of which is incorporated herein by reference. The data plotted in FIG. 1 shows that, while the fume emission rate increases significantly when heat input increases from 0.6 kJ/mm to 1.6 kJ/mm, the change in Mn content in the welding fume does not increase significantly over this heat input variance.

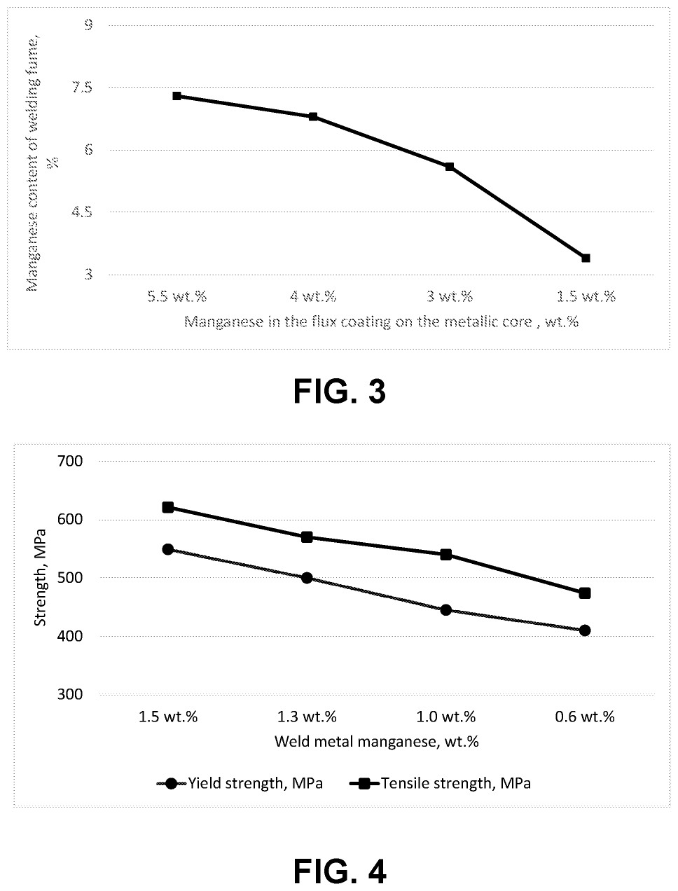

In the data plotted in FIG. 2, the Mn content in the flux coating for the metallic core of the E7018 electrode is varied at a constant heat input of 1.2 kJ/mm. As demonstrated in the data plot, the fume emission rate does not change significantly when varying Mn content from 1.5-5.5 wt % of the flux coating. However, the data plotted in FIG. 3 under the same conditions results in a reduction in Mn content of the welding fume when decreasing from 5.5 wt % to 1.5 wt % of the flux coating. In particular, reduction of Mn in the flux coating from 5.5 wt % to 1.5 wt % of the flux coating reduces Mn content in the welding fumes by greater than 60%. While this is beneficial from a welding safety standpoint, reducing manganese in the flux coating on the metallic core of the electrode (while maintaining all other elements and/or components constant within the flux coating) can also have a negative impact on welding and mechanical properties of the weld metal formed.

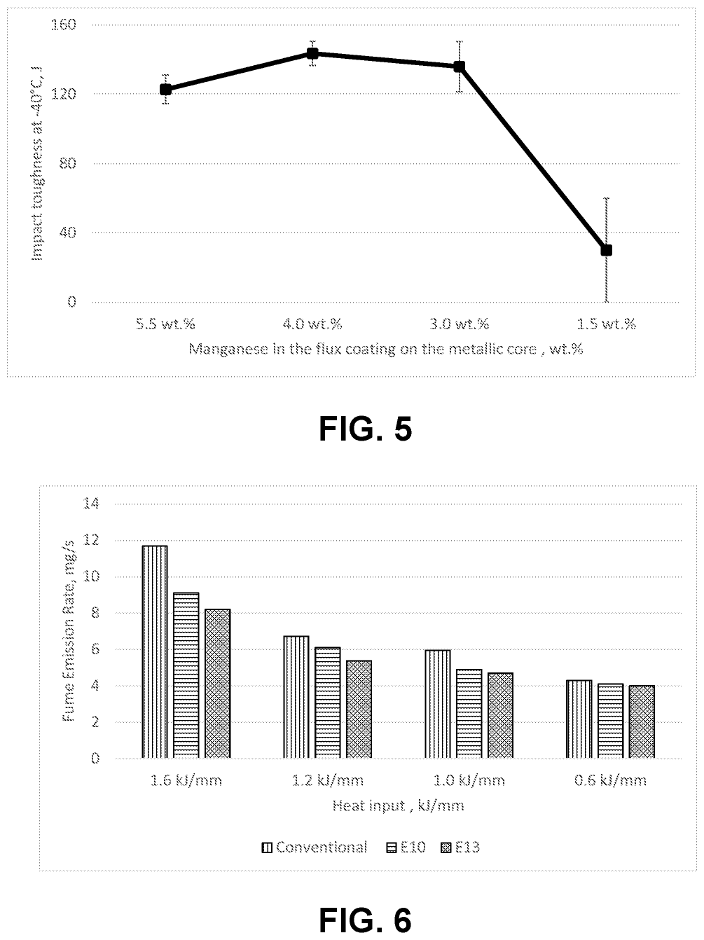

This is evident from the data plotted in FIGS. 4 and 5. The data obtained from these plots were based upon tests conducted using AWS 5.5/AWS 5.5M procedures with a 1.2 kJ/mm heat input. Referring to FIG. 4, the relationship between decreasing Mn content in the flux coating (while maintaining all other elements and other components constant) and yield and tensile strengths of resultant weld metal deposits is demonstrated. The reduction of Mn in the flux coating from 5.5 wt % to 1.5 wt % of the flux coating (without any other change made to the flux coating) results in a significant reduction of both the yield strength and the tensile strength of the weld metal deposit.

The Charpy V-notch impact toughness at −40° C. for weld metal deposits formed using electrodes coated with flux coatings having varied Mn content is depicted in FIG. 5, where it is demonstrated that impact toughness is lowered when Mn content was reduced from 5.5 wt. % to 1.5 wt. % within the flux coating (all other elements and components in the flux coating being held constant). The impact toughness was found to have significant scatter in electrodes containing 1.5 wt. % Mn in the flux coating, while providing more than 3 wt % Mn in the flux coating on the metallic core resulted in not much scatter and average impact toughness was 100 J or greater. The poor impact toughness along with significantly higher scatter in the electrode containing 1.5 wt % Mn in the flux coating is associated with the weld pad porosity caused by insufficient deoxidizers. In other words, weld pads from electrodes containing 1.5 wt % Mn in the flux coating (no other change to the flux coating) did not clear the Grade 1 radiography requirement as per AWS A5.5/A5.5M procedures.

As can be seen from the data presented in FIGS. 5 and 6, yield strength, tensile strength and impact toughness of the weld metal deposit formed from a conventional MSAW welding electrode are significantly affected when Mn in the flux coating on the metallic core of the electrode is reduced to as low as 1.5 wt % of the flux coating.

Welding electrodes (e.g., SMAW electrodes) are described herein in accordance with the present invention that enable reduction of Mn content in the flux coating to no greater than 1.5% of the flux coating while maintaining desirable physical properties of the weld metal deposit formed from such electrodes, including suitable weld metal yield strength and tensile strength as well as suitable impact toughness properties.

In example embodiments, the flux coating in low Mn electrodes can include a combination of elements, compounds and/or components as described herein, where each can compensate for reduction of Mn in the flux coating by providing one or more functionalities such as shielding agents, deoxidizers, arc stabilizers, binders, and metal/alloy powders. A shielding agent in the flux coating protects the molten weld pool against elements in the atmosphere (e.g., nitrogen and hydrogen). A deoxidizer functions as a scavenger that combines with oxygen to diffuse to the surface of the weld. An arc stabilizer increases the electrical conductivity of the electrical arc such that electric current is conducted more smoothly during welding. Binders promote the cohesion of components of the flux system together and/or maintain the desired shape of the electrode coating about the metallic core during normal handling. Metal and alloy powders help in attaining desired weld metal composition and further increase the deposition rate.

It has been determined that the addition and/or increase in amount of one or more, and preferably two or more, of carbon (C), silicon (Si), nickel (Ni), chromium (Cr), titanium (Ti) and/or boron (B) in the flux coating for a welding electrode or consumable compensates for reducing Mn in the flux coating so as to achieve a weld metal deposit having suitable or acceptable physical, mechanical and welding properties.

In embodiments described herein, the flux coated welding consumable or electrode (e.g., SMAW electrode) includes a metallic core and a flux coating surrounding the metallic core. The metallic core can be a hot rolled mild steel core including elements and components/compounds in amounts as described herein. The weight ratio of metallic core to flux coating in the consumable can range from about 70:30 (metallic core: flux coating) to about 60:40. In example embodiments, the weight ratio of metallic core to flux coating is 65:35.

In the embodiments described herein, the amount of Mn provided in the flux coating for the welding electrode is no greater than 5.5 wt % of the flux coating, preferably no greater than 4 wt % of the flux coating, or no greater than 3 wt % of the flux coating, or no greater than 2 wt % of the flux coating, and more preferably no greater than 1.5 wt % of the flux coating. The metallic core can include Mn in an amount from 0.01 wt % to 0.7 wt % of the core. The overall content or total amount of Mn in the electrode (based upon total weight of the electrode, i.e., flux coating and metallic core) can range from 0.50 wt % to 0.70 wt % of the electrode. In particular, maintaining the amount of Mn in the flux coating to a lower amount (e.g., less than 3 wt % and preferably no greater than 1.5 wt %) significantly reduces Mn in the welding fume to a desirable level.

The amount of carbon (C) can be provided in the flux coating (e.g., as graphite, carbon black and/or any other suitable type of carbonaceous material) in an amount from 0.01 wt % to 0.5 wt % of the flux coating, or from 0.05 wt % to 0.45 wt % of the flux coating, or preferably from 0.1 wt % to 0.35 wt % of the flux coating, or more preferably from 0.15 wt % to 0.30 wt % (e.g., 0.2 wt %) of the flux coating. The amount of carbon in the metallic core can range from 0.01 wt % to 0.1 wt %, while the total amount of carbon in the electrode can range from 0.05 wt % to 0.10 wt % of the electrode. Carbon can be added and/or increased within the flux coating to aid in strengthening of the weld metal deposit that is formed. Carbon (e.g., in the form of graphite) can also function as a deoxidizer within the flux coating.

The amount of silicon (Si) can be provided in the flux coating in an amount greater than 0.5 wt % of the flux coating. Preferably, the amount of Si is at least 1 wt % of the flux coating, or at least 2 wt % of the flux coating, and no greater than about 3.5 wt % of the flux coating. For example, the amount of Si in the flux coating can be about 3 wt %. The metallic core can include Si in an amount of 0.01 wt % to 1.0 wt % of the metallic core, while the total amount of Si in the electrode can range from 0.30 wt % to 0.50 wt % of the electrode. Increasing Si content in the flux coating helps to maintain yield strength and tensile strength as well as impact toughness of the weld metal deposit forming from the electrode with reduced Mn content in the flux coating. In addition, Si can also function as a deoxidizer within the flux coating.

The amount of each of nickel (Ni) and chromium (Cr) in the flux coating is no greater than 2.0 wt %, preferably no greater than 1.0 wt %, and mor preferably no greater than 0.5 wt % of the flux coating. The amount of each of Ni and Cr in the metallic core can be no greater than 0.1 wt % of the weight of the metallic core. The total amount of each of Ni and Cr in the electrode can range from 0.15 wt % to 0.25 wt % of the electrode. One or both of Ni and Cr can be added as elements and/or alloys to achieve desirable weld metal properties (e.g., less scatter or consistent impact toughness at −40° C.).

Titanium (Ti) can be provided in the flux coating in an amount no greater than 10 wt %, or no greater than 8 wt %, or no greater than 6 wt %, or no greater than 5 wt %, or no greater than 4 wt %, or no greater than 3 wt %, or no greater than 2 wt %, or no greater than 1 wt %, or no greater than 0.500 wt % (e.g., 0.400 wt %) of the flux coating. The amount of Ti in the metallic core can be no greater than 0.1 wt % of the weight of the metallic core, while the total amount of Ti in the electrode can range from 0.005 wt % to 0.030 wt % of the electrode. Titanium can provide desirable weld metal properties (e.g., enhanced yield strength and tensile strength0 and also, when provided in the flux coating, functions as a deoxidizer during the welding process.

The amount of Boron (B) that can be provided in the flux coating can be no greater than 5 wt %, or no greater than 4 wt %, or no greater than 3 wt %, or no greater than 2 wt %, or no greater than 1 wt %, or preferably no greater than 0.500 wt % of the flux coating. The amount of B in the metallic core can be no greater than 0.1 wt % of the weight of the metallic core, while the total amount of B in the electrode can range from 0.001 wt % to 0.010 wt % of the electrode. Boron can be provided as an alloying element for the weld metal. When provided in the flux coating, B functions as a deoxidizer during the welding process.

In example embodiments, the flux coating comprises a combination of at least three elements that function at least as deoxidizers. In one example embodiment, the flux coating comprises at least C (e.g., graphite), Mn and Si in the amounts as described herein. In another example embodiment, the flux coating comprises C (e.g., graphite), Mn, Si and Ti in the amounts as described herein. In a further example embodiment, the flux coating comprises C (e.g., graphite), Mn, Si, Ti and B in the amounts as described herein. In one specific example, the flux coating provided on the metallic core of a SMAW electrode comprises no greater than (e.g., up to) 0.5 wt % graphite, no greater than 5.5 wt % Mn, no greater than 5 wt % B, no greater than 3 wt % Si and no greater than 10 wt % Ti in the flux coating. The combinations of at least these combinations of elements in the indicated amounts within the flux coating may allow passing Grade 1 radiography requirements of all weld deposits by preferentially oxidizing gaseous elements that cause porosity.

The combination of one or more of Ni, Cr, Ti and B added in the amounts provided herein in the flux coating can also add to the alloys formed in the weld metal deposit which also ensures a desired Charpy V-notch impact toughness at −40° C. despite having a reduced Mn content in the flux coating. In example embodiments, the flux coating includes at least a combination of Cr and Ni in the amounts provided herein, or at least a combination of Ti and B in the amounts provided herein. In an example embodiment, the flux coating can comprise no greater than (e.g., up to) 2 wt % Ni, no greater than 2 wt % Cr, no greater than 5 wt % Ti and no greater than 1 wt % B of the flux coating.

Arc stabilizers can be provided in the flux coating in the form of minerals including, without limitation, titanium oxides (e.g., rutile), titanates (e.g., potassium titanate) and silicates, such as hydrous potassium silicates (e.g., mica) and/or aluminum silicates (e.g., feldspar). In example embodiments, the flux coating can include one or more of rutile, potassium titanate, feldspar and mica, each provided in an amount from 0 wt % to 15 wt % of the flux coating (e.g., up to 10 wt %, or up to 5 wt %). For example, the flux coating can include at least one of these arc stabilizers. In another example embodiment, the flux coating can include rutile and at least one of these other arc stabilizers, or a combination of rutile and potassium titanate, or a combination of rutile and mica, or a combination of rutile and feldspar.

Some non-limiting examples of binders provided in the flux coating include silicates, alginates and cellulose. The flux coating can include one or more binders in an amount (i.e., total amount of binder material) up to 20 wt %, or from 1 wt % to 20 wt %, or from 1 wt % to 15 wt %, or from 1 wt % to 10 wt % of the flux coating. For example, the flux coating can include one or more binders in an amount from 1 wt % to 8 wt %, or from 1 wt % to 6 wt %, or from 3 wt % to 5 wt % (e.g., 4 wt %) of the flux coating.

The flux coating can also include one or more shielding components including, without limitation, limestone and fluorspar, which can function to protect the molten weld pool during welding from other elements in the atmosphere (e.g., nitrogen and hydrogen), thus preventing or limiting diffusion of such elements into the weld. In example embodiments, the flux coating can include a shielding component (e.g., limestone and/or fluorspar) in an amount up to 70 wt %, or from 15 wt % to 70 wt %, or from 15 wt % to 60 wt %, or from 15 wt % to 50 wt %, or from 15 wt % to 40 wt %, or from 15 wt % to 30 wt %, or from 20 wt % to 30 wt % of the flux coating. In one example, the flux coating can include limestone and fluorspar at a weight ratio that is less than 3:1, or less than 2:1, or less than 1.3:1, or about 1.2:1 (limestone to fluorspar). This combination of limestone with fluorspar at the noted ratios can function to provide better shielding, and slag behavior as well as desirable bead aesthetics.

Iron (Fe) and other unavoidable impurities can also be provided in the flux coating. For example, iron powder can be provided in the flux coating in an amount up to 60 wt %, or from 10 wt % to 60 wt %, or from 10 wt % to 50 wt %, or from 10 wt % to 40 wt %, or from 20 wt % to 40 wt %, or from 30 wt % to 40 wt %. The presence of iron within the flux coating and in the amounts described herein can contribute to weld metal recover up to 120%.

The electrode (e.g., metallic core and/or flux coating) can also include other metals and/or other elements or compounds as desired for the electrode. For example, additional elements including, without limitation, nickel (Ni), aluminum (Al), molybdenum (Mo), vanadium (V), copper (Cu), cobalt (Co) and niobium (Nb) as well as certain rare earth elements, such as cerium (Ce), lanthanum (La), neodymium (Nd), praseodymium (Pr), etc., can also be present in the metallic core and/or the flux coating.

In one example embodiment, the metallic core comprises a hot rolled mild steel comprising (wt % values based upon weight of metallic core):
from 0.01 wt. % to 0.7 wt. % manganese,
from 0.01 wt. % to 0.1 wt. % carbon,
from 0.01 wt. % to 1 wt. % silicon, and
optionally one or more of:
   no greater than 0.1 wt % nickel,
   no greater than 0.1 wt % chromium,
   no greater than 0.1 wt % molybdenum,
   no greater than 0.1 wt % cobalt,
   no greater than 0.1 wt % titanium,
   no greater than 0.1 wt % boron,
   no greater than 0.2 wt % vanadium,
   no greater than 0.2 wt % niobium,
   no greater than 0.2 wt % copper,
   no greater than 0.2 wt % aluminum,
   no greater than 0.2 wt % rare earth elements, and
the balance being iron and any unavoidable impurities.

A reduced Mn flux coated metallic core electrode as described herein forms a weld metal deposit with desirable properties while minimizing Mn content in the welding fumes (e.g., less than 4 wt % Mn in the welding fumes) during an arc welding process utilizing a conventional or other heat input (e.g., no greater than 1.6 kJ/mm).

In an example embodiment, a weld metal deposit formed utilizing a reduced Mn flux coated metallic core electrode as described herein has the following composition (wt % values based upon weight of the weld metal deposit):
from wt. % 0.03 to 0.08 wt. % carbon,
from 0.4 wt. % to 0.6 wt. % manganese,
from 0.3 wt. % to 0.7 wt. % silicon,
one or more of:
   no greater than 0.3 wt. % nickel,
   no greater than 0.2 wt. % chromium,
   no greater than 0.2 wt. % molybdenum,
   no greater than 0.1 wt. % cobalt,
   no greater than 0.1 wt. % titanium,
   no greater than 0.1 wt. % boron,
optionally one or more of:
   no greater than 0.2 wt. % vanadium,
   no greater than 0.2 wt. % niobium,
   no greater than 0.2 wt. % copper,
   no greater than 0.2 wt. % aluminium,
   no greater than 0.2 wt. % rare earth elements, and
the balance iron and any unavoidable impurities.

The weld deposit can be formed utilizing the low Mn electrode having a tensile strength of at least 500 MPa, a yield strength of at least 420 MPa, a percentage elongation of at least 22%, a Charpy V-notch toughness of at least 47 J at −40° C., and a diffusible hydrogen amount of no greater than 4 ml/100 g. The total fume emission rate utilizing the low Mn electrode can be less than 8 mg/s at 1.6 kJ/mm heat input, less than 5 mg/s at 1.2 kJ/mm heat input, less than 3.5 mg/s at 1.0 KJ/mm heat input, and less than 2.5 mg at 0.6 kJ/mm heat input. Further, the total fume emission rate utilizing the low Mn electrode can be less than 8 mg/s at 810 mg/s melt rate, less than 5 mg/s at 495 mg/s melt rate, less than 3.5 mg/s at 378 mg/s melt rate, and less than 2.5 mg/s at 231 mg/s melt rate.

### EXAMPLES

In the following examples, various electrodes (E1-E13) were tested, where the electrodes were provided with different elements and/or at different amounts within the flux coating of the electrodes. Results of weld metal deposits formed from these electrodes are provided in the following tables.

In the examples, performance of a conventional E7018 electrode with flux coating including 4 wt % Mn in the flux coating was compared with other electrodes E1-E13, in which Mn content within the flux coating was set at 1.5 wt % of the flux coating as well as certain metals being added and/or modified in content. All tests were conducted using both AWS A5.5/A5.5M and EN ISO 2560-A E 42 4 B 42 H5 standards. The impact toughness tests were conducted at −40° C., at which the minimum requirement for acceptable EN ISO 2560-A E 42 4 B 42 H5 standard is 47 J, the minimum required yield strength is 420 MPa minimum, and the ultimate tensile strength required range is 530 to 640 MPa. A plurality of tests were conducted for each electrode type, and the average values are presented in the tables herein.

In a first series of tests, amounts of carbon and molybdenum were varied in electrodes E1-E4 in comparison to conventional (E7018) to determine to what extent such change might offset the otherwise negative effects of the reduced Mn content in the flux coating (from 4 wt % to 1.5 wt %). The comparison data is presented in Table 1:

TABLE 1
Conventional electrode and example electrodes E1-E4

| | Conventional | | | | |
|---|---|---|---|---|---|
| | (E7018) | E1 | E2 | E3 | E4 |
| Graphite in flux coating | — | — | 0.2 | — | 0.2 |
| (wt % of flux coating) | | | | | |
| Mn in flux coating (wt % | 4 | 1.5 | 1.5 | 1.5 | 1.5 |
| of flux coating) | | | | | |
| Si in flux coating (wt % | 1.8 | 1.8 | 1.8 | 1.8 | 1.8 |
| of flux coating) | | | | | |
| Mo in flux coating (wt % | — | — | — | 0.5 | 0.5 |
| of flux coating | | | | | |
| C in weld metal (wt % of | 0.05 | 0.05 | 0.07 | 0.05 | 0.07 |
| weld metal) | | | | | |
| Mn in weld metal (wt % | 1.2 | 0.58 | 0.56 | 0.57 | 0.59 |
| of weld metal) | | | | | |
| Si in weld metal (wt % of | 0.45 | 0.36 | 0.34 | 0.36 | 0.35 |
| weld metal) | | | | | |
| Mo in weld metal (wt % | 0.002 | 0.002 | 0.002 | 0.104 | 0.110 |
| of weld metal) | | | | | |
| Yield strength of weld | 500 | 410 | 442 | 451 | 476 |
| metal (MPa) | | | | | |
| Tensile strength of weld | 570 | 474 | 510 | 522 | 534 |
| metal (MPa) | | | | | |
| Elongation (%) | 28 | 26 | 29 | 28 | 31 |
| Impact toughness (J) at −40° C. | 144 ± 14 | 30 ± 65 | 32 ± 52 | 28 ± 61 | 21 ± 76 |

As indicated in Table 1, electrode E1 is only modified in relation to conventional by the reduced Mn content. Electrodes E2 and E4 include additional carbon (in comparison to the conventional and E1 electrodes) in the form of graphite provided within the flux coating in an amount of 0.2 wt %, and electrodes E3 and E4 include additional molybdenum (in comparison to the E2 and conventional electrodes) provided in the flux coating in an amount of 0.5 wt %.

The E1 electrode (only change is reduction in Mn content within flux coating in relation to conventional) does not perform well in that the weld deposit formed has yield strength and tensile strength that is less than the minimum specification requirements based on EN ISO 2560-A E 42 4 B 42 H5 standards. Further, the average impact toughness at −40° C. for the E1 electrode was reduced by more than 60% with a significantly higher scatter compared to the conventional electrode. The amount of silicon in the weld metal for the E1 electrode (and also the E2-E4 electrodes) was also reduced compared to the conventional electrode even though the coating contains a similar concentration of silicon (this may be associated with the deoxidation of silicon due to lower Mn content in the flux coating).

In comparing the E2 electrode with the E1 electrode, it was demonstrated that increasing only carbon content to compensate for reduction in Mn content in the flux coating results in an increase in each of yield strength and tensile strength by about 30 MPa while retaining a weld metal Mn content in the weld metal deposit near 0.6 wt. %. In comparing the E3 electrode with the E1 electrode, increasing only Mo content to compensate for reduction in Mn content in the flux coating also results in increase in yield strength and tensile strength to a slightly greater extent than the E2 electrode (addition of carbon content). Further, the addition of both carbon and Mo to the flux coating to compensate for reduced Mn content, as demonstrated by the E4 electrode, results in an even greater yield strength and tensile strength of the weld deposit. However, for each of the E1-E4 electrodes, the Grade 1 radiography requirement, as per AWS A5.5/A5.5M procedures, was not met and the minimum impact toughness at −40° C. (47 J) was not satisfied.

Further tests were conducted, with electrodes E5 and E6, in which carbon and Si were increased to compensate for reduced Mn content. The comparison data between conventional and the E5 and E6 electrodes is provided in Table 2:

TABLE 2
Conventional electrode and example electrodes E5 and E6

| | Conventional | | |
|---|---|---|---|
| | (E7018) | E5 | E6 |
| Graphite in flux coating | — | 0.2 | 0.2 |
| (wt % of flux coating) | | | |
| Mn in flux coating (wt % | 4.0 | 1.5 | 1.5 |
| of flux coating) | | | |
| Si in flux coating (wt % | 1.8 | 2.3 | 3.0 |
| of flux coating) | | | |
| C in weld metal (wt % of | 0.05 | 0.07 | 0.07 |
| weld metal) | | | |
| Mn in weld metal (wt % | 1.2 | 0.59 | 0.58 |
| of weld metal) | | | |
| Si in weld metal (wt % of | 0.45 | 0.40 | 0.46 |
| weld metal) | | | |
| Yield strength of weld | 500 | 468 | 490 |
| metal (MPa) | | | |
| Tensile strength of weld | 570 | 538 | 562 |
| metal (MPa) | | | |
| Elongation (%) | 28 | 28 | 27 |
| Impact toughness (J) at −40° C. | 144 ± 14 | 67 ± 68 | 112 ± 62 |

The addition of Si combined with carbon in the flux coating was found to improve the yield and tensile strengths as well as impact toughness for each of the E5 and E6 electrodes. In particular, the impact toughness of electrode E5, which included 2.3 wt. % of Si in the flux coating on the metallic core showed improved tensile and impact toughness values. Further increase of Si in the flux coating on the metallic core to a level of about 3 wt. % in electrode E6 produced acceptable tensile properties as per both AWS A5.5/A5.5M and EN ISO 2560-A E 42 4 B 42 H5. As Si content was increased in electrodes E5 and E6, the average impact toughness also trended upward (in comparison to the E1-E4 electrodes) to levels near those of the conventional electrode. The weld pad made with electrode E5 has acceptable porosity as per Grade 1 radiography requirement in AWS A5.5/A5.5M procedures. For the weld pad prepared with electrode E6, No Significant Defects (NSD) resulted as per Grade 1 radiography requirements in AWS A5.5/A5.5M procedures. However, each of electrodes E5 and E6 had a scatter issue similar to experimental electrodes E1 to E4.

In additional tests with electrodes E7-E10, combinations of carbon, Si, titanium (Ti) and Boron (B) were increased to compensate for reduced Mn content. The comparison data between conventional and the electrodes E7-E10 is provided in Table 3:

TABLE 3
Conventional electrode and example electrodes E7-E10

| | Conventional | | | | |
|---|---|---|---|---|---|
| | (E7018) | E7 | E8 | E9 | E10 |
| Graphite in flux coating | — | 0.2 | 0.2 | 0.2 | 0.2 |
| (wt % of flux coating) | | | | | |
| Mn in flux coating (wt % | 4 | 1.5 | 1.5 | 1.5 | 1.5 |
| of flux coating) | | | | | |
| Si in flux coating (wt % | 1.8 | 3.0 | 3.0 | 3.0 | 3.0 |
| of flux coating) | | | | | |
| Ti in flux coating (wt % | — | 2.0 | 4.0 | 8 | 4.0 |
| of flux coating | | | | | |
| B in flux coating (wt % | — | — | — | — | 0.5 |
| of flux coating | | | | | |
| C in weld metal (wt % of | 0.05 | 0.07 | 0.07 | 0.07 | 0.07 |
| weld metal) | | | | | |
| Mn in weld metal (wt % | 1.2 | 0.63 | 0.61 | 0.66 | 0.60 |
| of weld metal) | | | | | |
| Si in weld metal (wt % of | 0.45 | 0.52 | 0.55 | 0.52 | 0.55 |
| weld metal) | | | | | |
| Ti in weld metal (wt % | 0.008 | 0.02 | 0.03 | 0.05 | 0.02 |
| of weld metal) | | | | | |
| B in weld metal (wt % of | — | — | — | — | 0.006 |
| weld metal) | | | | | |
| Yield strength of weld | 500 | 501 | 517 | 535 | 506 |
| metal (MPa) | | | | | |
| Tensile strength of weld | 570 | 566 | 569 | 535 | 506 |
| metal (MPa) | | | | | |
| Elongation (%) | 28 | 26 | 26 | 29 | 24 |
| Impact toughness (J) at −40° C. | 144 ± 14 | 84 ± 61 | 108 ± 61 | 93 ± 60 | 98 ± 17 |

As set forth in Table 3, electrodes E7, E8 and E9 included 2 wt. %, 4 wt. % and 8 wt. % Ti, respectively in the flux coating on the metallic core, while electrode E10 included 4 wt. % Ti and 0.5 wt. % B in the flux coating on the metallic core. The impact toughness for each of electrodes E7, E8 E9, which included Ti in the weld metal deposit (up to 0.05 wt % of the weld metal), showed a similar trend as electrode E6 in Table 2. The weld pad prepared with electrode E10 containing both titanium and boron resulted in No Significant Defects (NSD) as per Grade 1 radiography requirements in AWS A5.5/A5.5M and, in turn, showed acceptable impact toughness values with minimal scatter.

Further testing was conducted, with electrodes E11-E13, with combinations of carbon, Si, Nickel (Ni) and Chromium (Cr) being increased to compensate for reduced Mn content. The comparison data between conventional and the electrodes E11-E13 is provided in Table 4:

TABLE 4
Conventional electrode and example electrodes E11-E13

| | Conventional | | | |
|---|---|---|---|---|
| | (E7018) | E11 | E12 | E13 |
| Graphite in flux coating | — | 0.2 | 0.2 | 0.2 |
| (wt % of flux coating) | | | | |
| Mn in flux coating (wt % | 4.0 | 1.5 | 1.5 | 1.5 |
| of flux coating) | | | | |
| Si in flux coating (wt % | 1.8 | 3.0 | 3.0 | 3.0 |
| of flux coating) | | | | |
| Ni in flux coating (wt % | — | 0.3 | — | 0.3 |
| of flux coating) | | | | |
| Cr in flux coating (wt % | — | — | 0.3 | 0.3 |
| of flux coating) | | | | |
| C in weld metal (wt % of | 0.05 | 0.07 | 0.07 | 0.07 |
| weld metal) | | | | |
| Mn in weld metal (wt % | 1.2 | 0.54 | 0.56 | 0.54 |
| of weld metal) | | | | |
| Si in weld metal (wt % of | 0.45 | 0.46 | 0.44 | 0.45 |
| weld metal) | | | | |
| Ni in weld metal (wt % | — | 0.18 | — | 0.19 |
| of weld metal) | | | | |
| Cr in weld metal (wt % | — | — | 0.15 | 0.13 |
| of weld metal) | | | | |
| Yield strength of weld | 500 | 490 | 488 | 492 |
| metal (MPa) | | | | |
| Tensile strength of weld | 570 | 561 | 556 | 565 |
| metal (MPa) | | | | |
| Elongation (%) | 28 | 27 | 27 | 28 |
| Impact toughness (J) at −40° C. | 144 ± 14 | 127 ± 86 | 98 ± 66 | 158 ± 19 |

Electrodes E11 and E12 represent electrodes of flux coating containing 0.3 wt % Ni and 0.3 wt % Cr, respectively, which showed a similar impact toughness trend as compared to electrode E6 from Table 2. Electrode E13, which includes Ni and Cr in the prescribed concentrations, showed good impact toughness with minimal scatter, equivalent to the toughness of the evaluated conventional electrode including 4 wt. % Mn in the flux coating on the metallic core. The weld pad prepared with electrode E13 containing both Ni and Cr also resulted in No Significant Defects (NSD) as per Grade 1 radiography requirements in AWS A5.5/A5.5M.

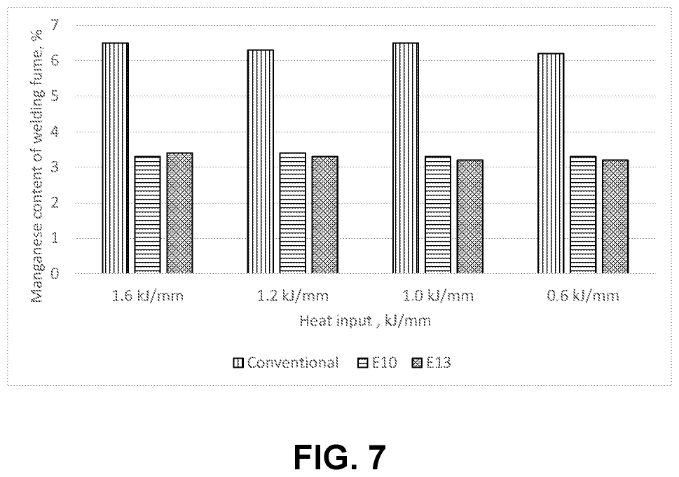

From the experimental data set forth for electrodes E1-E13, it was determined that electrodes E10 and E13 meet both AWS A5.5/A5.5M and EN ISO 2560-A E 42 4 B 42 H5 requirements. Fume test results of conventional electrodes (E7018) and electrodes E10 and E13 are depicted in the data plots of FIGS. 6 and 7. There is no major negative effect on the fume emission rate at heat inputs over a range of 0.6-1.6 kJ/mm in the electrodes E10 and E13 compared to conventional electrodes. This is true even with the Mn content being lowered significantly within the flux coating of the flux coated E10 and E13 electrodes.

Examples of electrodes including the flux coating chemistries of the E10 and E13 electrodes are provided as follows:

TABLE 5
Electrode compositions for E10 and E13

| | E10 | E13 |
|---|---|---|
| Content in flux coating | | |
| (wt % of flux coating) | | |
| C (e.g., graphite) | 0.20 | 0.20 |
| Mn | 0.15 | 0.15 |
| Si | 1.80 | 3.00 |
| Ni | 0.300 | 0.300 |
| Cr | 0.300 | 0.300 |
| Ti | 4.000 | 0.400 |
| B | 0.500 | 0.001 |
| Content in metallic core | | |
| (wt % of metallic core) | | |
| C (e.g., graphite) | 0.01-0.10 | 0.01-0.10 |
| Mn | 0.01-0.7 | 0.01-0.7 |
| Si | 0.01-1 | 0.01-1 |
| Ni | up to 0.1 | up to 0.1 |
| Cr | up to 0.1 | up to 0.1 |
| Ti | up to 0.1 | up to 0.1 |
| B | up to 0.1 | up to 0.1 |
| Total content of electrode | | |
| (wt % of electrode) | | |
| C (e.g., graphite) | 0.06 | 0.07 |
| Mn | 0.63 | 0.55 |
| Si | 0.43 | 0.35 |
| Ni | 0.20 | 0.19 |
| Cr | 0.15 | 0.13 |
| Ti | 0.024 | 0.009 |
| B | 0.005 | 0.000 |
| Weld metal deposit | | |
| properties | | |
| Yield strength of weld | 506 | 492 |
| metal (MPa) | | |
| Tensile strength of weld | 506 | 565 |
| metal (MPa) | | |
| Elongation (%) | 24 | 28 |
| Impact toughness (J) at −40° C. | 98 ± 17 | 158 ± 19 |

Note:
all values for elements in Table 5 may vary by no more than ±0.01.

Thus, flux coated metallic core electrodes used in arc welding (e.g., SMAW) as described herein yield weld metal deposits with desirable physical properties while also significantly reducing Mn content in the welding fumes that are generated during the welding process. Unique combinations of metals at amounts as described herein are provided in the flux coating for the electrodes which compensate for the reduced Mn content in the flux coating.

It will be appreciated that the electrodes described herein can find application in the fabrication of offshore structures, pipeline and other steel structures.

While the present invention has been disclosed with reference to certain embodiments, numerous modifications, alterations and changes to the described embodiments are possible without departing from the spirit and scope of the invention, as defined in the appended claims. Accordingly, it is intended that the present invention not be limited to the described embodiments, but that it has the full scope defined by the language of the following claims, and equivalents thereof.

What is claimed:

1. A welding consumable comprising:
a metallic core; and
a flux coating surrounding a portion of the metallic core, wherein the flux coating comprises, by weight of the flux coating:
manganese in an amount no greater than 4 wt %;
carbon in an amount from 0.01 wt % to 0.5 wt %;
silicon in an amount from 2 wt % to 3.5 wt %; and
at least two of the following:
nickel in an amount no greater than 2 wt %;
chromium in an amount no greater than 2 wt %;
titanium in an amount no greater than 10 wt %; and
boron in an amount no greater than 5 wt %.

2. The welding consumable of claim 1, wherein the flux coating comprises manganese in an amount no greater than 2 wt % of the flux coating.

3. The welding consumable of claim 1, wherein the flux coating comprises nickel and chromium.

4. The welding consumable of claim 1, wherein the flux coating comprises titanium and boron.

5. The welding consumable of claim 1, wherein the flux coating further comprises iron in an amount up to 60 wt % of the flux coating.

6. The welding consumable of claim 1, wherein the flux coating further comprises a shielding component in an amount up to 70 wt % of the flux coating, the shielding component comprising limestone.

7. The welding consumable of claim 6, wherein the shielding component within the flux coating further comprises fluorspar.

8. The welding consumable of claim 1, wherein the flux coating further comprises one or more of the following, by weight of the flux coating:
from 0 wt % to 15 wt % rutile,
from 0 wt % to 15 wt % potassium titanate,
from 0 wt % to 15 wt % feldspar, and
from 0 wt % to 15 wt % mica.

9. The welding consumable of claim 1, wherein the flux coating further comprises one or more binders in an amount from 1 wt % to 20 wt % of the flux coating, the one or more binders comprising one or more of a silicate, an alginate and cellulose.

10. The welding consumable of claim 1, wherein the metallic core comprises, by weight of the metallic core:
from 0.01 wt. % to 0.7 wt. % manganese,
from 0.01 wt. % to 0.1 wt. % carbon,
from 0.01 wt. % to 1 wt. % silicon, and
optionally one or more of:
no greater than 0.1 wt % nickel,
no greater than 0.1 wt % chromium,
no greater than 0.1 wt % molybdenum,
no greater than 0.1 wt % cobalt,
no greater than 0.1 wt % titanium,
no greater than 0.1 wt % boron,
no greater than 0.2 wt % vanadium,
no greater than 0.2 wt % niobium,
no greater than 0.2 wt % copper,
no greater than 0.2 wt % aluminum,
no greater than 0.2 wt % rare earth elements, and
the balance being iron and any unavoidable impurities.

11. The welding consumable of claim 1, wherein use of the welding consumable in an arc welding process generates a welding fume that contains less than 4 wt % manganese by weight of the welding fume.

12. A weld metal deposit formed from the welding consumable of claim 1, the weld deposit comprising, based upon a weight of the weld metal deposit:
from wt. % 0.03 to 0.08 wt. % carbon,
from 0.4 wt. % to 0.6 wt. % manganese,
from 0.3 wt. % to 0.7 wt. % silicon,
one or more of:
no greater than 0.3 wt. % nickel,
no greater than 0.2 wt. % chromium,
no greater than 0.2 wt. % molybdenum,
no greater than 0.1 wt. % cobalt,
no greater than 0.1 wt. % titanium,
no greater than 0.1 wt. % boron,
optionally one or more of:
no greater than 0.2 wt. % vanadium,
no greater than 0.2 wt. % niobium,
no greater than 0.2 wt. % copper,
no greater than 0.2 wt. % aluminium,
no greater than 0.2 wt. % rare earth elements, and
the balance iron and any unavoidable impurities.

13. The weld metal deposit of claim 12, wherein the weld metal deposit has a tensile strength of at least 500 MPa, a yield strength of at least 420 MPa, a percentage of elongation of at least 22%, a Charpy V-notch toughness of at least 47 J at −40° C., and a diffusible hydrogen amount of no greater than 4 ml/100 g.
